(19) United States
(12) Patent Application Publication
(10) Pub. No.: US 2015/0283034 A1
(43) Pub. Date: Oct. 8, 2015

(54) Portable Pill Crushing and Mixing Device

(71) Applicant: ANTONIO FERNANDEZ, Miami, FL (US)

(72) Inventor: ANTONIO FERNANDEZ, Miami, FL (US)

(21) Appl. No.: 14/244,896

(22) Filed: Apr. 4, 2014

(51) Int. Cl. A61J 7/00; B01F 7/00; B01F 3/12; B02C 18/12; B02C 18/18

(52) U.S. Cl. CPC A61J 7/0007; B02C 18/12; B02C 18/18; B01F 3/1271; B01F 7/0025; B01F 2003/125; B01F 2215/0032

(57) ABSTRACT

A pill crushing and mixing device crushes a pill, and then mixes the resultant fine particles with a fluid to form a palatable mixture. The subsequent mixture can pour from an open end of the device, and be ingested without bad taste or large indigestible composition of a whole pill. The device is generally lightweight, portable, and separates into two separate housings for cleaning and maintenance. An upper housing includes an upper blade and a lower blade that simultaneously rotate to create a synergy that optimizes crushing the pill, and mixing of the resultant fine particles and fluid. Blade beveled edges grind the pill and guide the mixture towards a base end and a sidewall for further mixing capacity. An upper gear and a lower gear transmit torque to the blades. A lower housing includes a safety switch motor, and circuitry. A handle enhances manipulation of the device.

### BACKGROUND

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

The following is an example of a specific aspect in the prior art that, while expected to be helpful to further educate the reader as to additional aspects of the prior art, is not to be construed as limiting the present invention, or any embodiments thereof, to anything stated or implied therein or inferred thereupon.

The present invention is directed to a pill crushing and mixing device that crushes a pill, and then mixes the resultant fine particles with a fluid to form a mixture. The subsequent mixture is more palatable than the pill alone, and can be ingested without the large indigestible composition of a whole pill.

It is known that a pill is a small, round, solid pharmaceutical oral dosage form of medication or supplement. The pill is manufactured by mixing the active ingredients with an excipient such as glucose syrup to form a paste, then rolling the mass into a long cylindrical shape, and dividing it into equal portions, which were then rolled into balls, and often coated with sugar to make them more palatable. Typically, pills include tablets, capsules, and variants thereof like caplets.

Often, the medicinal composition of pills creates an undesirable taste. The pills can also be large, relative to the esophagus and throat. Some users may not be capable of swallowing large, badly tasting pills due to physical disorders and handicapped conditions. For example, many geriatrics have difficulty swallowing tablets. Furthermore, users who must ingest nutrients through oral feeding tubes cannot swallow individual medication dosages formed as pills. The bad taste often associated with medicine may also make the pill indigestible.

Typically, breaking the pill down into smaller constituents can be performed to alleviate some of these problems. A mortar and pestle can be used for this purpose. However, the mortar and pestle has certain problems inherent with its use. First, the mortar and pestle must be thoroughly cleaned after each use to prevent the matter with which it is next used from becoming contaminated with the residue from the last substance with which it was used.

Secondly, crushed powder adhering to the mortar or the pestle can reduce the ultimate dosage transferred to the patient resulting in sub-standard treatment. Third, the mortar and pestle is operated manually, which may cause inconsistent results in the particle size of the crushed pills. The portion of the dose to be lost when incorrect pressure is applied at an angle which permits some of the material to exit the mortar. This also may leave a bad taste with the larger granules of the pill.

Often, adding a sweet liquid to the pills helps eliminate the bad taste and overly large size of a pill. However, for the pill to uniformly dissolve in the liquid, the pill must be broken up into a fine powder form. The liquid must also be thoroughly mixed with the powder form of the pill. Containing and controllably pouring the resultant mixture of the pill powder and the liquid can also be problematic. For example, if the container is insufficiently dimensioned to both mix the powdered form of the pill with the liquid, and also regulate distribution of the resultant mixture.

For the foregoing reasons, there is a pill crushing and mixing device that crushes a pill, and then mixes the resultant fine particles with a fluid to form a mixture. Two blades work together to optimize the crushing and mixing process. The resultant mixture enhances the palatability and facilitates ingestion of the pill.

Pill crushers have been used in the past; yet none with the present pill crushing and mixing capacity of the present invention. See U.S. Pat. Nos. 4,003,523; 4,765,549; and 7,975,943.

For the foregoing reasons, there is a portable pill crushing and mixing that optimizes crushing and mixing of a pill with a liquid to enhance palatability and facilitate ingestion of the pill.

### SUMMARY

The present invention is directed to a pill crushing and mixing device that crushes a pill, and then mixes the resultant fine particles with a fluid to form a palatable mixture. The pill may include an oral dosage of medication or supplement. The fluid may include a flavored liquid. The resultant mixture is more palatable than the pill alone, and can be ingested without the large indigestible composition of a whole pill. The present invention may be effective for enabling ingestion of the pill to a user having a physical disability.

The device includes a pair of blades that simultaneously rotate to create a synergy for optimizing crushing of the pill, and mixing of the resultant fine particles and fluid. The resultant mixture can easily pour from an open end of the device, and be ingested with little of the bad taste or large indigestible composition of a whole pill. The device is generally lightweight, portable, and separates into two separate housings for cleaning and maintenance.

In some embodiments, the device includes two detachably joined housings. An upper housing forms a space for the fluid to combine and mixes with the pill. The upper housing includes an open end for receiving the pill and the fluid. The open end is capped by a detachable lid that moves between an open position and a closed position. The lid regulates entry of the pill and the fluid, and also enables facilitated pouring of the subsequently formed mixture from the upper housing. The upper housing further includes a base end and a sidewall that contains the resultant mixture until consumption. In an embodiment of the invention the upper housing and the lid will be transparent.

The upper housing arranges a pair of blades in a generally concentric position for optimal engagement with the pill and the fluid. The pair of blades work in conjunction to crush the pill. In one embodiment, an upper blade is arranged concentrically to the upper housing. The upper blade rotatably engages the pill and the fluid. The upper blade includes an upper beveled edge that applies a substantially grinding force on the pill, creating a force sufficient to break the pill into a fine particle. The upper beveled edge is oriented to force the fine particles and the fluid in a downward direction, towards the base end.

A lower blade is arranged directly beneath, and in alignment with the upper blade. The lower blade configured to rotate simultaneously with the upper blade. The lower blade receives the fine particles and fluid from the upper blade for further crushing and mixing. In this manner, the dual blades create an enhanced fine particle that is easily soluble in the fluid and does not have sufficient surface area to create an undesirable taste. The lower blade includes a lower beveled edge that pushes the fine particles towards the base end. The proximal positioning of the lower blade to the base end forces the mixture to flow up the sidewall. This upward flow towards the open end creates additional agitation between the fine particles and the fluid for further enhancing the mixture.

In some embodiments, a lower housing mates with, and positions beneath the upper housing. The lower housing contains the power and gears for operating the pair of blades. A gear system, power, and circuitry operatively join the upper housing with the lower housing. In some embodiments, the lower housing comprises an upper gear that couples with the upper blade to transfer torque for rotating the upper blade. A lower gear couples with the lower blade to transfer torque for rotating the lower blade. A motor operatively joins the gears to selectively actuate the upper and lower gear to a desired speed. An operational switch for regulating the motor, and a power outlet cord for accessing power complete the circuitry.

In some embodiments, the device includes a handle for facilitating manipulation of the device and pouring the mixture from the upper housing. The handle also operates the lid for moving between an open position and a closed position. The handle extends from the lid to the lower housing. The handle includes a handle upper end that pivotally attaches with a mount on the lid. The handle further includes a handle lower end that detachably fastens to a handle notch in the lower housing. The handle lower end and the handle notch are secured through frictional force or other fastening means to place the lid in a closed position. The handle lower end and the handle notch are disengaged to pivotally move the lid towards an open position. A safety switch operatively joins the handle notch, and deactivates the motor when the handle lower end and the handle notch are disengaged. In this manner, the blades are not rotating from the open position.

One objective of the present invention is to enable ingestion of the pill to a user having a physical disability.

Another objective is to enhance the palatability of the pill by crushing the pill into a fine particle and mixing the fine particle with a flavored liquid.

Another objective is to optimize crushing the pill by utilizing two rotating blades working simultaneously.

Another objective is to optimize mixing the fine particles and fluid by utilizing two rotating blades working simultaneously, and forcing the mixture to agitate further by forcing a flow against the base end and upwardly along the sidewall.

Another objective is to facilitate cleaning and maintenance by providing detachable, separate components for the device.

Another objective is to deactivate the device when the lid is in an open position through a safety switch that operatively attaches to the handle.

Another objective is to restrict spillage of the mixture by forming a snug closed surface between the lid and the open end through beveled 3° mating surfaces.

Another objective is to enhance maneuverability of the device by providing a ridged grip on the handle.

### DRAWINGS

These and other features, aspects, and advantages of the present invention will become better understood with regard to the following description, appended claims, and drawings where:

FIG. 1 is a detailed perspective view of an exemplary pill crushing and mixing device;

FIG. 2 is a blow up view of an exemplary pill crushing and mixing device;

FIG. 3 is a top view of an exemplary lid;

FIG. 4 is a detailed perspective view of an exemplary upper blade and an exemplary lower blade;

FIG. 5 is a detailed perspective view of an exemplary upper gear and an exemplary lower gear;

FIG. 6 is a detailed sectioned side view of an exemplary pill crushing and mixing device powered by a battery that may be rechargeable; and

FIG. 7 is a detailed sectioned side view of an embodiment of the exemplary pill crushing and mixing device that is powered by an AC power source.

### DESCRIPTION

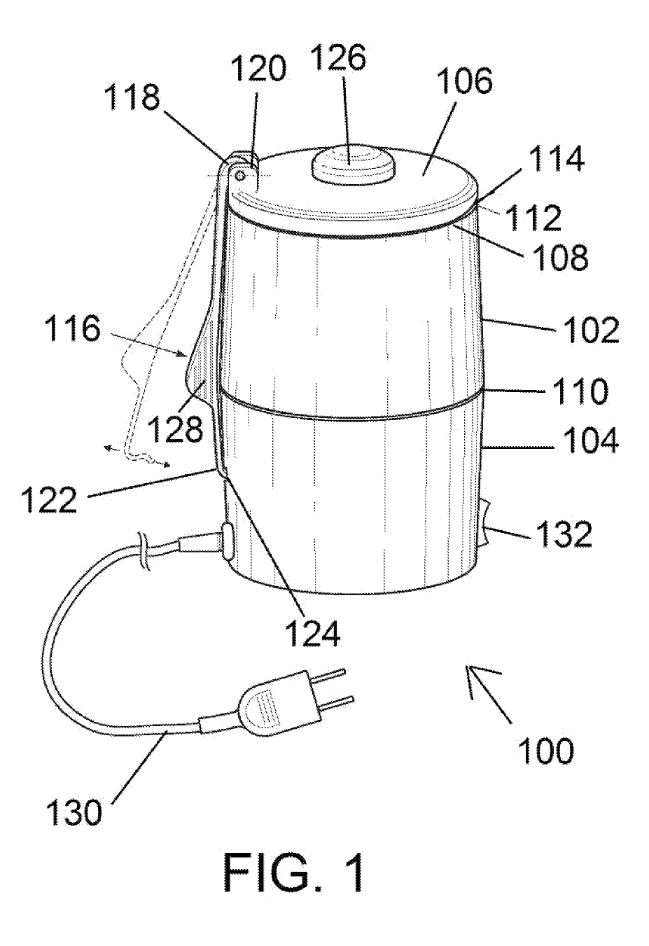

FIGS. 1-6 illustrate one embodiment of a pill crushing and mixing device 100. The present invention is directed to a pill crushing and mixing device 100 that enhances a taste and ingestion of a pill (not shown) by crushing the pill and mixing the resultant fine particle with a fluid (not shown). The pill may include an oral dosage of medication or supplement. The fluid may include a flavored or sweetened liquid. The subsequent mixture, often in a liquid state, is pourable from an open end 108 of the device 100. Through the optimal crushing and mixing functions, the mixture is made more palatable, and can be ingested with little of the bad taste or large indigestible composition of a whole pill. The device 100 is generally lightweight, portable, and separates into multiple components for cleaning and maintenance. The device 100 optimizes the crushing and mixing process with novel components and orientations thereof.

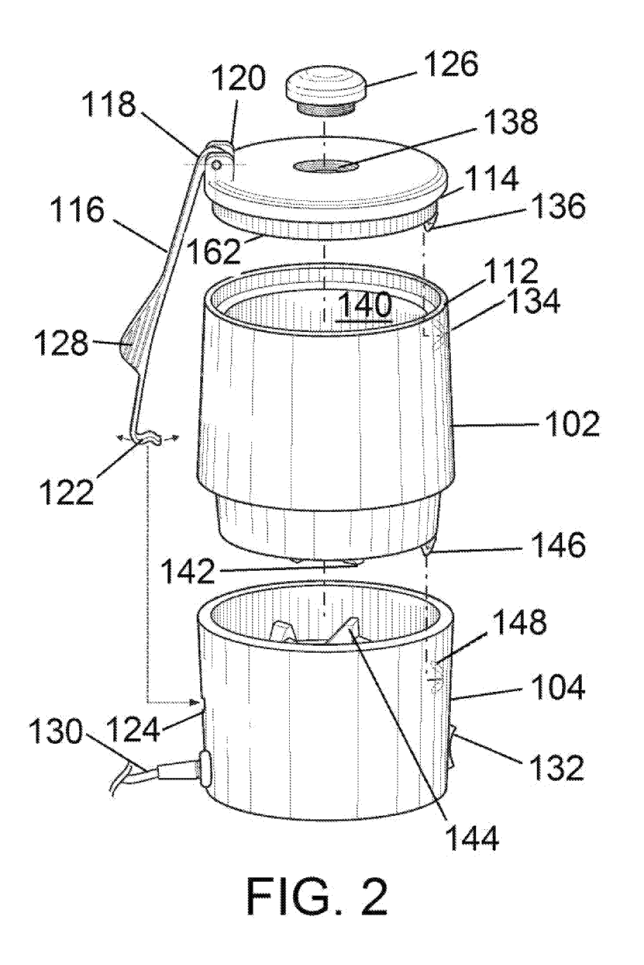

As referenced in FIG. 1, an upper housing 102 is configured to contain the pill and the fluid for crushing and mixing into a mixture. The upper housing 102 comprises an open end 108 configured to receive the pill and the fluid. A lid 106 selectively covers the open end 108; and thereby regulates access to the upper housing 102 by pivotally moving between an open position and a closed position over the open end 108. In some embodiments, the lid 106 may include a screw cap 126 that would allow a user to a pill or a liquid to the upper housing. The screw cap 126 is configured to threadably engage a concentric aperture 138 in the lid 106 (FIG. 2). In some embodiments the upper housing and the lid are transparent.

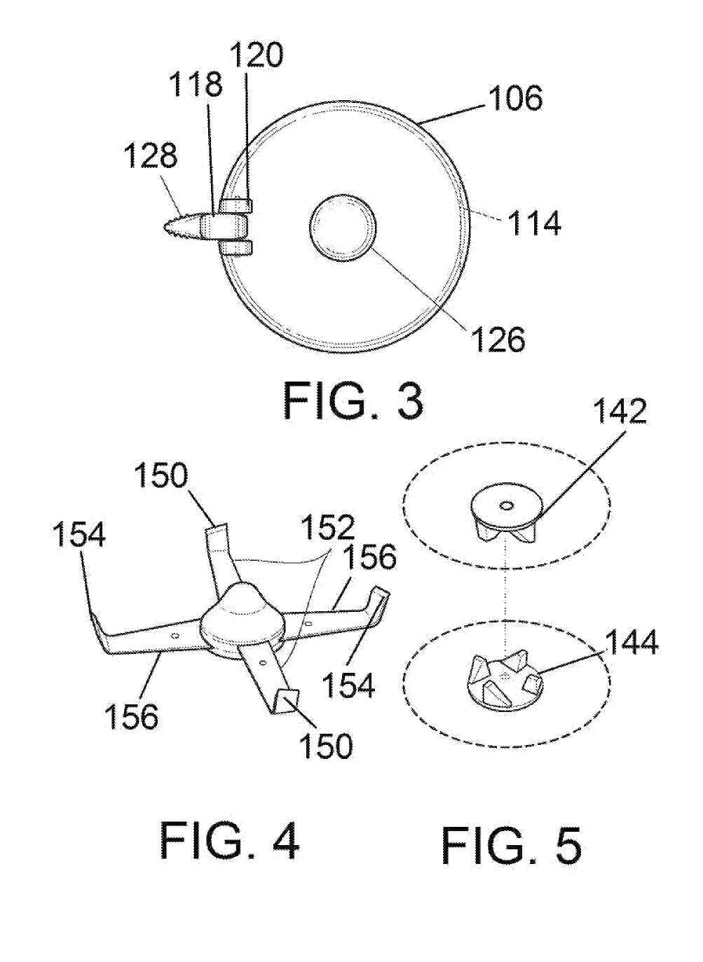

Turning now to FIG. 3, the lid 106 comprises a lid inner surface 162. The lid inner surface 162 forms a lid beveled periphery 114, which in one embodiment forms a slope of about 30°. The open end 108 forms a corresponding open end beveled periphery 112, also having a slope of about 3°. The open end beveled periphery 112 is configured to form a snug contact surface with the lid beveled periphery 114. In this manner, spillage of the mixture may be restricted.

The lid inner surface 162 further comprises a lid clip 136 for fastening the lid 106 into the closed position. The lid clip 136 detachably joins a lid clip notch 134 on the sidewall 140 for fastening the lid 106 to the upper housing 102 into the closed position. The lid clip 136 may have a curved configuration that creates a frictional locking with the lid clip notch 134. Though, a slight tilt of lid 106 may be utilized to disengage the lid clip 136 from the lid clip notch 134. However in other embodiments, any number of fastening means may be utilized to fasten the lid 106 to the upper housing 102, including, without limitation, a magnet, an adhesive, a screw, a hook and loop fastener, and a button.

In some embodiments, the upper housing 102 further comprises a base end 110 and a sidewall 140 configured to contain the mixture. The upper housing 102 may be shaped as a cylindrical container. However, various other shapes for the upper housing 102 may be utilized, including, without limitation, a rectangle, a rhombus, a square, a pyramid, and an elongated oval. Suitable materials for the upper housing 102 may include, without limitation, a rigid polymer, glass, or stainless steel.

As referenced in FIG. 4, the upper housing 102 performs the crushing and mixing through the use of a generally concentrically positioned upper blade 150. The upper blade 150 is configured to rotatably engage the pill and the fluid. The upper blade 150 comprises an upper beveled edge 152 configured to apply a substantially grinding force on the pill for deforming the pill into a fine particle. While performing the crushing function, the upper beveled edge 152 is sloped to guide the fine particle and the fluid towards the base end 110. The rotational movement of the upper beveled edge 152 along with the orientation of the slope force the fine particles and the fluid towards the base end 110.

The upper housing 102 further comprises a lower blade 154 arranged in alignment with, and below the upper blade 150. The lower blade 154 is configured to receive the fine particle and the fluid from the upper blade 150. The lower blade 154 rotatably engages the fine particle and the fluid simultaneously with the upper blade 150. The lower blade 154 comprises a lower beveled edge 156 configured to apply a substantially grinding force on the fine particle for additional crushing of the fine particle. This secondary crushing affect makes the crushed pill more soluble in the fluid. The upper and lower blades 150, 154 extend across the upper housing 102 to form a blade span 162. The blade span 162 is sufficiently long to maximize contact with the fluid and the fine particles.

Similar to the upper beveled edge 152, the lower beveled edge 156 guides the fine particles and the fluid towards the base end 110 and the sidewall 140. Together, the upper blade 150 and the lower blade 154 rotatably mix the fine particle with the fluid for creating the mixture. Additionally, the upper blade 150 and the lower blade 154 force the mixture to flow into the base end 110 and upwardly along the sidewall 140. The forcible flow of the mixture along the sidewall 140 works to increase agitation between the fine particle and the fluid, which enhances the mixing process. The optimal mixing provided by the upper and lower blades 150, 154 working together dilutes any undesirable taste that may be found in the pill.

Turning back to FIG. 2, the device 100 may include a lower housing 104 arranged to detachably join with the upper housing 102. The lower housing 104 is shaped and dimensioned in substantially the same manner as the upper housing 102. The lower housing 104 contains generally, the power and gear components for operating the upper and lower blades 150, 154 that operate in the upper housing 102. The lower housing 104 may separate from the upper housing 102 for cleaning and maintenance.

In one embodiment, the upper housing 102 comprises a housing clip 146 configured to detachably join a housing clip notch 148 on the lower housing 104 for fastening the upper housing 102 to the lower housing 104. The housing clip 146 may have a hook shaped configuration that creates a frictional locking with the housing clip notch 148. The housing clip 146 can be disengaged from the housing clip notch 148 by lifting the lid 106 and slightly tilting upper housing 102 away from lower housing 104. However in other embodiments, any number of fastening means may be utilized to fasten the upper housing 102 to the lower housing 104, including, without limitation, a magnet, an adhesive, a screw, a hook and loop fastener, and a button.

FIG. 5 illustrates an upper gear 142 and a lower gear 144 found in the upper 102 and lower housing 104 respectively. The lower housing 104 includes the concentrically positioned lower gear 144. The lower gear 144 is arranged to mate with, and rotatably control the upper gear 142. Specifically, the upper gear 142 transfers torque to the upper and lower blades for actuating rotation. The upper gear 142 may be arranged directly beneath the lower gear 144 for operatively controlling the upper and lower blades. The upper gear 142 is arranged to mate with the upper and lower blades 150 and 154 respectively. The upper gear 142 transfers torque to the upper and lower blades for actuating rotation.

In some embodiments, a handle 116 joins the device 100 to facilitate manipulation thereto, such as for opening the lid 106, pouring out the mixture, or moving between the open and closed positions. The handle 116 includes a grip 128 for providing a surface to grasp the handle 116. The grip 128 may include a plurality of ridges. The handle 116 is generally arranged to extend from the lid 106 to the lower housing 104.

The handle 116 comprises a handle upper end 118 that pivotally attaches to the lid 106 through a mount 120. The mount 120 forms a pivot point for enabling the handle 116 to pivotally move the lid 106 to the open position, or lock the lid 106 into the closed position. A pin may pass through apertures in the mount 120, whereby the handle 116 pivots off the mount 120.

The handle 116 further comprises a handle lower end 122 configured to detachably fasten with a handle notch 124 in the lower housing 104. A safety switch 160 operatively joins the handle notch 124. The safety switch 160 is configured to deactivate the device 100 when the handle lower end 122 and the handle notch 124 are disengaged. In this manner, the handle lower end 122 serves the dual purpose of opening the lid 106 and deactivating the device 100 while in the open position.

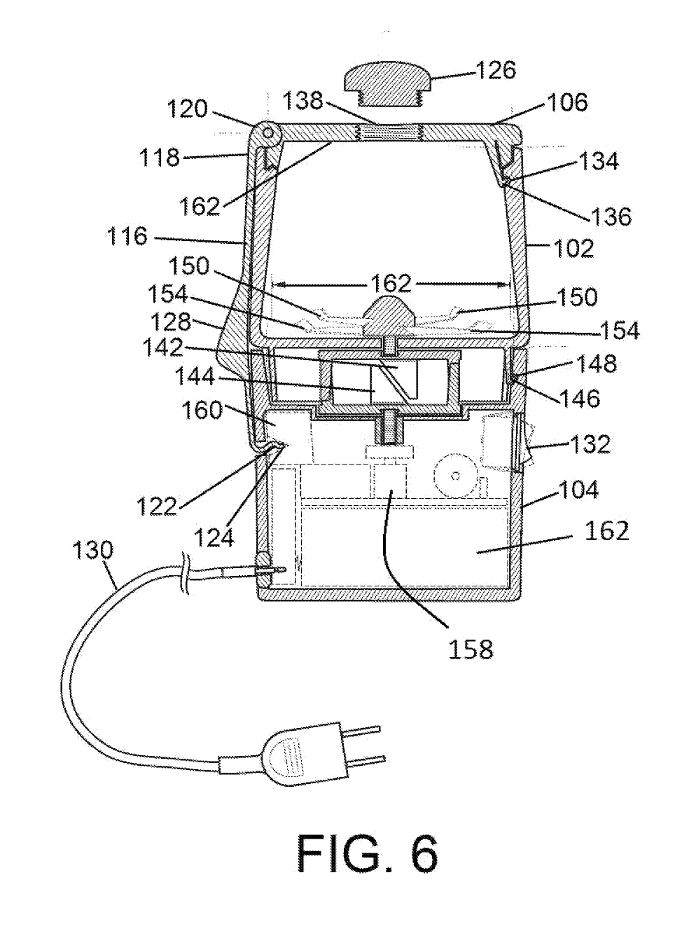

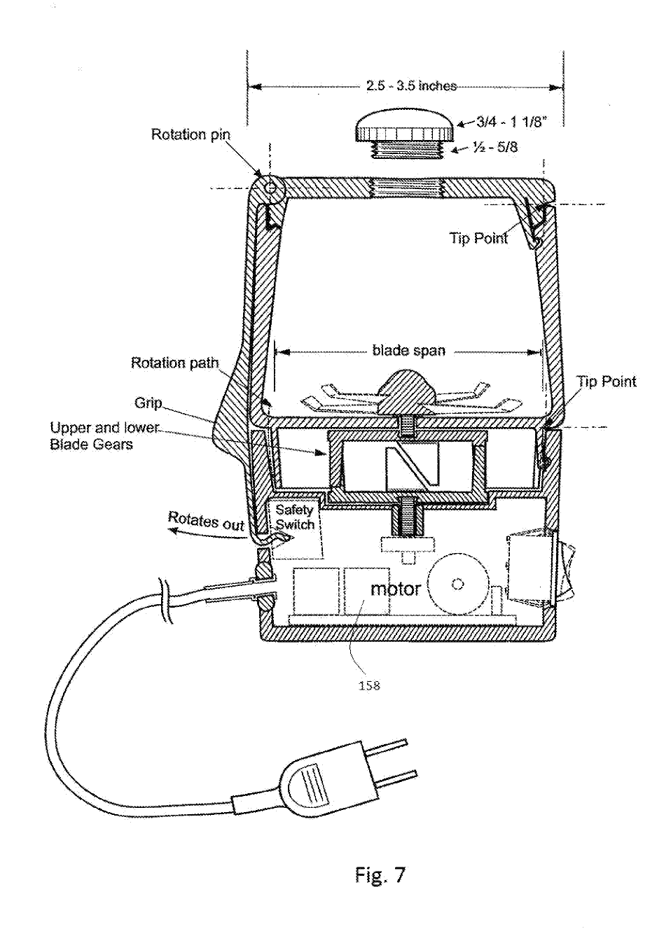

As referenced in FIG. 6, the lower housing 104 comprises a motor 158 configured to power the upper gear 142 and the lower gear 144. The motor 158 operatively connects to the gears through circuitry to selectively actuate the upper and lower gear 144 to a desired speed and torque. In one embodiment, the motor 158 is AC or DC powered. An operational switch 132, accessible from outside the lower housing 104 is configured to regulate the motor 158. The operational switch 132 may power on and off the motor 158, vary the speed of the motor 158, and provide a timing device. A power outlet cord 130 transmits an electrical current to the motor 158. However in other embodiments, the motor 158 may receive power from a battery 162 that is attached to the power outlet cord 130 to further enhance the portable capacities of the device 100.

While the inventor's above description contains many specificities, these should not be construed as limitations on the scope, but rather as an exemplification of several preferred embodiments thereof. Many other variations are possible. For example, the pill crushing and mixing device 100 could be utilized to crush rocks and mix in a chemical composition in a building construction facility. Accordingly, the scope should be determined not by the embodiments illustrated, but by the appended claims and their legal equivalents.

What is claimed is:

1. A pill crushing and mixing device for enhancing a taste and ingestion of a pill, the device comprising:
an upper housing configured to contain a pill and a fluid for crushing and mixing into a mixture,
the upper housing comprising an open end configured to receive the pill and the fluid, the upper housing further comprising base end and a sidewall configured to contain and enhance mixing of the mixture,
the upper housing further comprising an upper blade arranged concentrically to the upper housing, the upper blade configured to rotatably engage the pill and the fluid, the upper blade comprising an upper beveled edge configured to apply a substantially grinding force on the pill for deforming the pill into a fine particle, the upper beveled edge further configured to guide the fine particle and the fluid towards the base end,
the upper housing further comprising a lower blade arranged in alignment below the upper blade, the lower blade configured to receive the fine particle and the fluid from the upper blade, the lower blade further configured to rotatably engage the fine particle and the fluid, the lower blade comprising a lower beveled edge configured to apply a substantially grinding force on the fine particle for additional crushing, the lower beveled edge further configured to guide the fine particle and the fluid towards the base end and the sidewall,
wherein the upper blade and the lower blade are further configured to simultaneously mix the fine particle with the fluid for creating the mixture,
wherein the upper blade and the lower blade are further configured to force the mixture to flow into the base end and upwardly along the sidewall, the forcible flow of the mixture configured to increase agitation between the fine particle and the fluid for enhanced mixing and the upper and lower blades are attached to an upper gear,
the upper housing further comprising a lid configured to regulate access through the open end; and
a lower housing disposed to detachably join with the upper housing,
the lower housing comprising an lower gear arranged to mate with the upper gear, the upper gear configured to transfer torque to the upper and lower blades for actuating rotation.

2. The device of claim 1, in which the upper housing comprises a generally cylindrical shape.

3. The device of claim 2, in which the lid comprises a screw cap, the screw cap is configured to engage a concentric aperture defined in the lid.

4. The device of claim 3, in which the lid comprises a handle configured to facilitate manipulation of the device, the handle arranged to extend from the lid to the lower housing.

5. The device of claim 4, in which the handle comprises a handle upper end configured to pivotally attach with a mount on the lid, the handle further comprising a handle lower end configured to detachably fasten with a handle notch in the lower housing.

6. The device of claim 5, in which the handle comprises a grip for enhancing manipulation of the handle, the grip comprising a plurality of ridges.

7. The device of claim 6, in which the lid comprises a lid inner surface, the lid inner surface comprising a lid beveled periphery, the lid beveled periphery comprising a slope of about 3 degrees.

8. The device of claim 7, in which the open end comprises an open end beveled periphery, the open end beveled periphery comprising a slope of about 3 degrees, the open end beveled periphery configured to mate with the lid beveled periphery.

9. The device of claim 8, in which the lid beveled periphery and the open end beveled periphery comprise rubber gaskets.

10. The device of claim 9, in which the lid inner surface comprises a lid clip configured to detachably join a lid clip notch on the sidewall for fastening the lid to the upper housing into a closed position.

11. The device of claim 10, in which the upper housing comprises a housing clip configured to detachably join a housing clip notch on the lower housing for fastening the upper housing to the lower housing.

12. The device of claim 11, in which the lower housing comprises a generally cylindrical shape.

13. The device of claim 12, in which the lower housing comprises a motor configured to power the upper gear and the lower gear.

14. The device of claim 13, in which the lower housing comprises a safety switch arranged to operatively join the handle notch, the safety switch configured to deactivate the motor when the handle lower end and the handle notch are disengaged.

15. The device of claim 14, in which the lower housing comprises an operational switch configured to regulate the motor.

16. The device of claim 15, wherein the lower housing further comprises of a battery that powers the motor.

17. The device of claim 16, wherein the lower housing comprises a power outlet cord that recharges the battery.

18. The device of claim 15, wherein the lower housing comprises a power outlet cord that powers the motor.

19. The device of claim 18, wherein the upper housing and the lid are transparent.

20. The device of claim 1, wherein the upper housing and the lid are transparent.
